(19) United States
(12) Patent Application Publication
(10) Pub. No.: US 2014/0233753 A1
(43) Pub. Date: Aug. 21, 2014

(54) HEADPHONES WITH CLOUD INTEGRATION

(71) Applicant: Matthew Waldman, New York, NY (US)

(72) Inventor: Matthew Waldman, New York, NY (US)

(21) Appl. No.: 14/178,151

(22) Filed: Feb. 11, 2014

Related U.S. Application Data
(60) Provisional application No. 61/763,091, filed on Feb. 11, 2013.

(51) Int. Cl. H04R 1/10

(52) U.S. Cl. CPC H04R 1/1091; H04R 1/1041; H04R 2430/01
USPC 381/74

(57) ABSTRACT

Described herein is a portable acoustic device including a headband adapted to go over or around a user's head, and a pair of earpieces each being slidably attached to the headband. One of the pair of earpieces or the headband includes, a control interface, a battery, at least one transceiver configured to transmit and/or receive electromagnetic signals, and an electronic circuit configured to wirelessly interact with an audio source available on a network or a device via the at least one transceiver.

### CROSS-REFERENCE TO RELATED APPLICATIONS

This application claims priority to U.S. Provisional Patent Application Ser. No. 61/763,091, filed Feb. 11, 2013, which is hereby incorporated by reference herein in its entirety.

### FIELD OF THE INVENTION

The invention relates generally to acoustic systems, and more particularly to portable, wireless headphones.

### BACKGROUND OF THE INVENTION

Typically, headphones are used for listening to audio media on the go. Most headphones interact with audio sources using a wire that carries an audio signal from the audio source to the headphone, which then converts the audio signal to a sound. The wire, however, is cumbersome and prone to tangling and/or breaking when a person is moving, e.g., during exercise. Headphones that can interact with audio sources wirelessly are required. Moreover, as the number of people sourcing their audio media from the internet increases, wireless headphones that can source audio media from the internet are required.

### SUMMARY OF THE INVENTION

According to an aspect of the present disclosure, a portable acoustic device includes a headband configured to secure the portable acoustic device to a user's head, a pair of earpieces each being attached to the headband, a controller, a battery, at least one transceiver configured to transmit and/or receive electromagnetic signals, an electronic circuit configured to interact with an audio source available on a network or a device via the at least one transceiver, and/or other components. In an implementation, the controller, the battery, the transceiver, and/or the electronic circuit may be housed within the earpiece and/or the headband.

This disclosure is not limited to the particular systems, devices, or methods described herein. Further, as used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

### BRIEF DESCRIPTION OF THE DRAWING FIGURES

In the disclosure, reference is made to the accompanying drawing figures, which form a part hereof. In the drawing figures, similar symbols typically identify similar components, unless context dictates otherwise. The illustrative implementations described in the detailed description, drawings, and claims are not meant to be limiting. Other implementations may be used, and other changes may be made, without departing from the spirit or scope of the subject matter presented herein. It will be readily understood that the aspects of the disclosure, as generally described herein, and illustrated in the drawing figures, can be arranged, substituted, combined, separated, and designed in a wide variety of different configurations, all of which, are explicitly contemplated herein.

FIG. 1 depicts a perspective view of a portable acoustic device, according to an aspect of the present disclosure.

FIG. 2 depicts a cross-section view of a headband of the portable acoustic device illustrated in FIG. 1, according to an aspect of the present disclosure.

FIG. 3 depicts an alternative implementation of the portable acoustic device illustrated in FIG. 1, according to an aspect of the present disclosure.

FIG. 4 depicts a close-up view of a control interface for the portable acoustic device illustrated in FIG. 1, according to an aspect of the present disclosure.

FIG. 5 depicts a perspective view of an alternative implementation of a portable acoustic device, according to an aspect of the present disclosure.

FIG. 6 depicts an example of a control interface for the portable acoustic device illustrated in FIG. 5, according to an aspect of the present disclosure.

### DETAILED DESCRIPTION OF THE INVENTION

Described herein are portable acoustic devices and method of making the portable acoustic devices. In an implementation, a portable acoustic device described herein includes a headband configured to secure the portable acoustic device to a user's head, a pair of earpieces each being attached to the headband, a control interface, a battery, at least one transceiver configured to transmit and/or receive electromagnetic signals, an electronic circuit configured to wirelessly interact with an audio source available on a network or a device via the at least one transceiver and/or other components. In an implementation, the controller, the battery, the transceiver, and/or the electronic circuit may be housed within the earpiece and/or the headband.

In an implementation, the at least one transceiver is configured to receive wireless signals such as, for example, WiFi, Bluetooth, Radio, Cellular, Satellite, WiGig, WiDi, ZigBee, and the like. Such transceivers enable the portable acoustic device to interact with one or more audio sources. The audio sources may include, for example, a network (e.g., a service that provides audio through the internet), or a device such as a music device (e.g., Walkman, iPod, etc.), a television, a desktop or mobile computer, a game console, an alarm system, and the like. The audio source device may or may not be connected to the network.

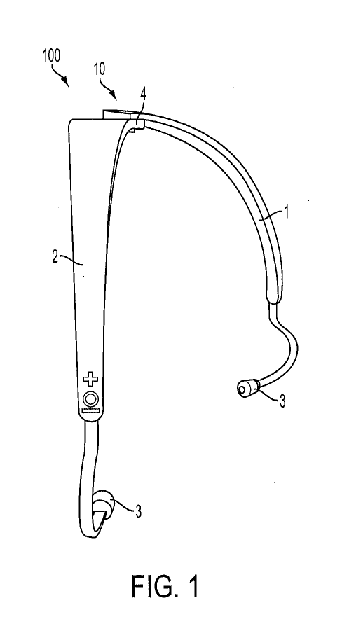

FIG. 1 depicts a perspective view of a portable acoustic device 100, according to an implementation. The headband 10, in such an implementation, may include a first portion 1 and a second portion 2 each having an earpiece 3 coupled thereto at one end thereof. In an implementation, earpiece 3 may be slidably connected to first portion 1 or second portion 2, although other coupling mechanisms may be used. First portion 1 and second portion 2 are connected at their respective ends opposite the earpiece 3 by a hinge 4 such that first portion 1 and second portion 2 are symmetrically disposed about hinge 4. In an implementation, hinge 4 has multiple locking positions such that first portion 1 and second portion 2 can be locked at various angles with respect to each other, allowing a user to adjust the distance between the earpieces for wearing comfort. Each earpiece 3 can be slidably moved into or out of the respective portion it is attached to such that the effective length of the headband can be increased or decreased for wearing comfort. In an implementation, portable acoustic device 100 may be folded about hinge 4 such that earpieces 3 rest adjacent to each other. In such an implementation, a magnetic clamp (not explicitly illustrated) may be included to hold the first portion 1 and the second portion 2 together.

While an ear-bud type earpiece that can be partially inserted in an ear of a user is illustrated in FIG. 1, any other type of earpiece can be used in various implementations of portable acoustic device 100. For example, the earpiece may be an ear-muff type earpiece adapted to cover the entire ear of the user (e.g., for noise cancellation), or an on-ear type earpiece that partially covers the user's ear.

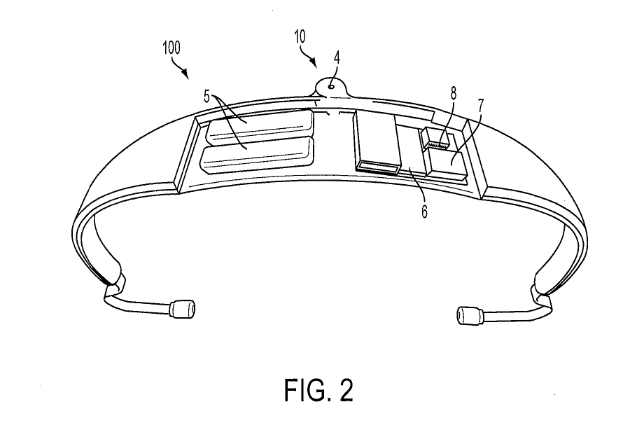

FIG. 2 depicts a cross-section view of headband 10 according to an aspect of an invention. Headband 10, in the implementation illustrated in FIG, 2, includes a battery 5, an electronic circuit 6, and a transceiver 7, which may be adapted to transmit and/or receive electromagnetic signals. In some implementations, headband 10 may also include, for example, a subscriber identity module (SIM) card holder 8 and a SIM card (not explicitly shown) to allow headband 10 to communicate using Cellular signals using protocols such as GSM, GPRS, CDMA, EDGE, UMTS, HSPDA, LTE, WiMAX, and so forth.

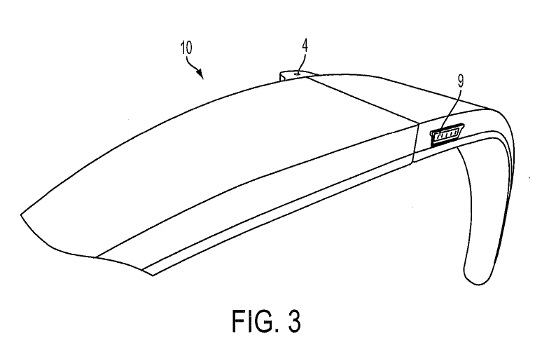

Transceiver 7 allows portable acoustic device 100 to interact with an audio source wirelessly using electromagnetic signals. As described above, the audio source may be a network (e.g., a service that provides audio through the internet), or a device that may or may not be connected to the network. Not explicitly illustrated in FIG. 2 are electrical connections between the various components present in headband 10. In various implementations, battery 5 may be a primary battery (e.g., a disposable AA or AAA battery) or a rechargeable battery (e.g., a lithium ion battery). For example, an implementation depicted in FIG. 3 includes a charging port 9 (e.g., mini USB, micro USB, lightning, and so forth) connected to the rechargeable battery 5 illustrated in FIG. 2.

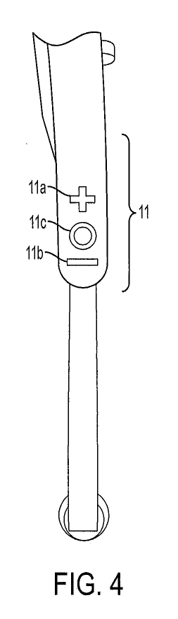

FIG. 4 depicts a close-up view of an implementation of a control interface 11 for portable acoustic device 100. Control interface 11 illustrated in FIG. 4 includes a pair of volume control buttons 11a and 11b (for increasing and decreasing the volume respectively), and a pause-play button 11c.

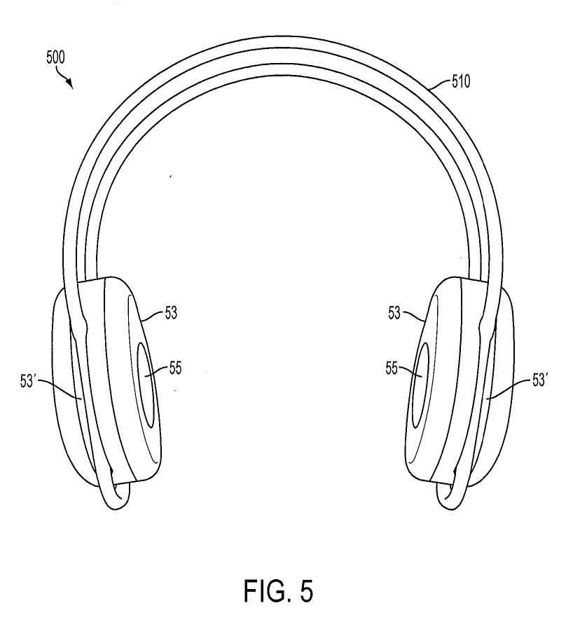

FIG. 5 depicts an alternate implementation of the portable acoustic device 500 in accordance with aspects of the present disclosure. In this implementation, ear-muff type earpieces 53 are used. Earpieces 53 include recessed grooves 53′ provided along a side of earpiece 53. The headband 510 rests within recessed grooves 53′ such that speaker portions 55 of earpieces 53 face toward each other. Recessed grooves 53′ are provided such that a position of earpieces 53 along the headband can be adjusted for the comfort and preference of the use.

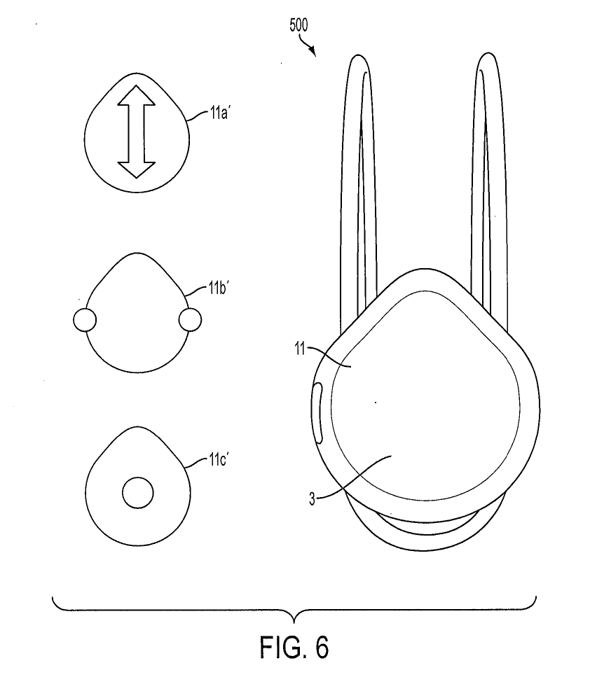

In various implementations, control interface 11 (illustrated in FIG. 4) may not necessarily include buttons. For example, in the implementation depicted in FIG. 6, control interface 11 is included as a touch-sensitive surface on an ear-muff type earpiece (illustrated in FIG. 5). In such an implementation, for example, volume 11a′ can be controlled by touching, tapping or swiping a up or down on an external surface the earpiece. Manipulation of pause-play control 11c′ is achieved by tapping or touching a central portion of the external surface of the earpiece and manipulation of track-change 11b′ function can be achieved by tapping or touching a left or right portion of the external surface of the earpiece.

It should be noted that the control interfaces depicted in FIGS. 4 and 6 are merely examples and other configurations are possible. As an example, the volume control interface and the track-change function illustrated in FIG. 6 can be interchanged. In another configuration the control interfaces may be distributed between the two earpieces. For example, the right earpiece may be provided with volume control and the left earpiece may be provided with the other controls. Moreover, other alternate or additional controls can be provided within the control interface. For example, an interface or a button (not explicitly shown) for powering the device down can be included in the control interface. In yet another implementation, control interfaces may be programmable such that the user is able to choose which interfaces control which functions according to their convenience and preference.

In some implementations, the portable acoustic device 100 and/or 500 may include a microphone (not explicitly illustrated in any of the figures) and/or an indicator (e.g., an LED light) (not explicitly illustrated in any of the figures) provided along one of the earpieces. The microphone, in some implementations, can be used to provide audio commands to portable acoustic device 500. For example, a user may control volume or track using audio commands provided to the portable acoustic device. In such implementations, the electronic circuit included within the portable acoustic device may be configured for voice recognition. Other alternate or additional uses for the microphone are possible in various implementations of the portable acoustic device. For example, when the portable acoustic device is provided with a SIM card, the portable acoustic device can work as a cellular phone that can receive and/or make phone calls. In such implementations, the microphone can be used for controlling the phone and also as a means to communicate during the phone call. In such implementations, additional controls may be provided to the portable acoustic device. For example, a control interface dedicated for answering and/or ending phone calls may be additionally or alternatively provided. In some other implementations, the portable acoustic device can pair with another device such as, for example, a smartphone using, for example, Bluetooth protocol. In such implementations, the microphone may be used to provide audio commands to the other device including, for example, to communicate during a phone call associated with the other device.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A portable acoustic device comprising:
a headband configured to secure the portable acoustic device to a user's head;
one or more of earpieces each coupled to the headband;
a control interface used to control audio playback;
a battery;
at least one transceiver configured to transmit and receive electromagnetic signals; and
an electronic circuit configured to wirelessly interact with an audio source via the at least one transceiver.

2. The portable acoustic device of claim 1, wherein the transceiver is configured to transmit and receive signals using one or more of WiFi, Bluetooth, Radio, Cellular, Satellite, WiGig, WiDi, and ZigBee communication protocols.

3. The portable acoustic device of claim 1, wherein the control interface comprises one or more buttons or touch-sensitive surfaces.

4. The portable acoustic device of claim 1, wherein the portable acoustic device is configured to directly receive an audio media via a network.

5. The portable acoustic device of claim 1, wherein the battery is a rechargeable battery and the portable acoustic device further comprises a charging port connected to the battery.

6. The portable acoustic device of claim 1, wherein control of audio playback includes control of one or more of volume, pause-play function and track-change function.

7. The portable acoustic device of claim 1, wherein the control interface, the battery, the at least one transceiver, and/or the electronic circuit is housed within the headband.

8. The portable acoustic device of claim 1, wherein the control interface, the battery, the at least one transceiver, and/or the electronic circuit is housed within the one or more earpieces.

9. The portable acoustic device of claim 1, wherein the one or more earpieces are slidably attached to the headband.

10. The portable acoustic device of claim 1, wherein the one or more earpieces are configured as earbuds.

11. The portable acoustic device of claim 10, wherein the headband includes the control interface.

12. The portable acoustic device of claim 10, wherein the headband includes a center hinge about which the headband is foldable to collapse the portable acoustic device.

13. The portable acoustic device of claim 1, wherein the one or more earpieces are each configured as an ear muff.

14. The portable acoustic device of claim 13, wherein the ear muff includes the control interface.

15. The portable acoustic device of claim 13, wherein the control interface comprises a touch-sensitive input.

16. The portable acoustic device of claim 14, wherein the touch-sensitive input comprises a first region associated with an audio volume increase that when touched causes the audio volume to increase and second region associated with an audio volume decrease that when touched decreases the audio volume.

17. The portable acoustic device of claim 14, wherein the touch-sensitive input comprises a first region associated with a track change function that when touched causes the portable acoustic device to play a next audio track and second region associated with the track change function that when touched causes the portable acoustic device to repeat an audio track and/or play a previous audio track.

18. The portable acoustic device of claim 14, wherein the touch-sensitive input comprises a region associated with a pause-play function that when touched causes the portable acoustic device to pause a playing audio track or play a paused audio track.

19. The portable acoustic device of claim 1, further including a microphone for receiving audio input.
